(19) United States
(12) Patent Application Publication
(10) Pub. No.: US 2007/0018476 A1
(43) Pub. Date: Jan. 25, 2007

(54) Sun visor

(76) Inventor: Dominik Pallmer, Stuttgart (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/543,170

(22) PCT Filed: Jan. 20, 2004
(86) PCT No.: PCT/EP04/00382

§ 371 Date: Jan. 6, 2006

(30) Foreign Application Priority Data
Jan. 24, 2003 (DE) 103 02 675.4

(51) Int. Cl. B60J 3/00; B60R 7/05

(52) U.S. Cl. 296/97.1; 296/97.5; 224/312

(57) ABSTRACT

The invention relates to a sun visor (1) for motor vehicles, comprising a hollow visor body (10). According to the invention, the sun visor (1) has a slotlike receiving opening (3) and a receiving area (31) arranged in the cavity of the visor body, this receiving area (31) forming a receiving element for holding a flat object (2), such as, for example, parking tickets or fuel cards.

### BACKGROUND AND SUMMARY OF THE INVENTION

This invention relates to a sun visor for motor vehicles.

German document DE 196 35 684 A1 describes a sun visor for a motor vehicle which, in the sun visor body, forms a trough-shaped depression with a bearing flange. It is possible for various built-in modules of the sun visor to be mounted in the depression, such as concealable or illuminable mirrors or mirror units with integrated pockets for receiving parking tickets.

German document DE 43 40 685 A1 describes a sun visor with a mirror unit fitted therein, it being the case here that the receiving element for flat objects to be accommodated is formed as a ticket clip and holds the object on the mirror housing.

The object of the invention is to provide a sun visor having a receiving element for customary flat objects, such as parking tickets, fuel cards or the like, which is designed as simply as possible and at the same time has a particularly inconspicuous appearance.

This object is achieved by means of a sun visor as claimed. Sun visors having hollow plastic visor bodies are involved here. The visor body of a sun visor according to the invention has a receiving area which is arranged in the cavity of the visor body. Furthermore, a slotlike receiving opening is made in the visor body, via which receiving opening it is possible for flat objects to be inserted at least partially into the inner receiving area.

A sun visor for vehicles is usually constructed as a flat body which has two relatively large, approximately parallel faces and a peripheral, usually rounded, edge which connects the two faces. The faces of the visor body usually have a rectangular to oval outline, it being possible for the visor body to have a varying thickness over the extent of the faces, with the peripheral edge having a corresponding height and form. Curved visor bodies are also conceivable.

The sun visor is essentially made up of a rigid base element, the visor body. The visor body may be hollow or else plate-shaped. Furthermore, fastening elements for suspending the sun visor in the vehicle are formed or applied on or in the visor body. The rigid visor body may be lined with a textile, a film or a foam skin or may form a particular surface by itself.

A slotlike shape of the receiving opening is provided when the opening has, perpendicular to the direction of the path of insertion of the object, a cross section with an elongate extent, that is to say has a significantly larger main dimension in one direction and a significant smaller main dimension in another direction transversely thereto.

Sun visors for motor vehicles are usually able to pivot about an axis, arranged in the region of the upper edge of the windshield and oriented along the extent thereof, between an inoperative position against the vehicle roof frame and an antiglare position against the windshield. In an embodiment of a sun visor according to the invention, the slotlike receiving element is arranged on that side which bears against the windshield in the antiglare position and is therefore directed toward the occupant in the inoperative position and thus easily accessible for said occupant. It is thus possible, in particular when the sun visor is used as a parking ticket holder, for the parking ticket to be inserted into the receiving slot with the sun visor in the inoperative position, and by folding the sun visor down into the antiglare position the parking ticket lies against the windshield and is thus visible to inspection officials.

A first embodiment of the sun visor has a visor body which is manufactured from two assembled half-shells. Consequently it is possible, on the one hand, to configure the inwardly directed side of the visor body, and thus the inner receiving area. Furthermore, a receiving opening arranged in the continuous face of the sun visor can be produced easily.

The receiving opening can be made by machining or cutting, but is ideally produced during the primary forming manufacturing step for the visor body.

The half-shells can be produced by plastic injection molding, which offers particularly simple manufacture and possibilities for configuring the inner receiving area and the receiving opening. Further possible production processes are likewise deep-drawing or compression-forming processes, which allow the use of plastically deformable materials, such as, for example, metallic materials of high-grade appearance, for the visor body.

Apart from a simple construction made up of two half-shells of approximately the same size, structural modifications, such as, for example, a half-shell with a cover or with a covering fabric, are also conceivable.

An embodiment of the sun visor in which the receiving opening is integrated into the separating joint of the visor parts has the particular advantage that the receiving opening can be produced in a particularly simple manner, since no peripherally closed opening contour has to be made in a continuous surface. This produces the possibility of, for example, simpler molds in the case of injection molding or the provision of a receiving opening in the case of blow-molded plastic parts.

In an embodiment of the sun visor, the object is clamped for example between three bearing points when being inserted. In this process, the object is bent with a continuous curvature. When the object is deflected or bent a number of times, for example in an undulating receiving contour, there are more than three bearing points.

The object is pushed at an acute angle with respect to the sun visor face through the receiving opening into the cavity of the visor body. In this process, the object in the cavity of the sun visor bears against a first half-shell arranged opposite the receiving opening and against two bearing points or bearing edges in the receiving openings. During further insertion, the bearing point on the first half-shell moves and the object is braced and wedged between the three bearing points. This makes it possible to dispense with separate retaining or clamping components within or on the sun visor.

The clamping operation described can also be improved by functional elements on the inner side of the half-shell which are ideally produced during injection molding or forming.

An embodiment has, on the inner side of the half-shells, ribs which can be produced in a simple manner, for example by injection molding, the free edge of which, which is arranged toward the receiving area, is oriented in the insertion movement of the object. In this way the ribs form within the cavity of the sun visor an insertion and bearing or clamping contour for the object which is to be introduced.

An embodiment has, in the receiving area, a bearing point or a bearing region which, by virtue of its own elastic flexibility, also improves the clamping of rigid objects or objects of different thickness.

The function may be achieved by a spring clip, for example, or else by a foam or elastomer body arranged in this region of the receiving element. The elastic element here may display further functions, such as, for example, the formation of insertion contours.

In a sun visor with elastic bearing points, clamping by means of two bearing points is conceivable. This can be achieved in the manner of a clip by means of two bearing points which are situated opposite one another at the front and rear of the object, in which case at least one side is designed to be elastically flexible.

A further embodiment of the sun visor clamps the object by bending it transversely with respect to the direction of insertion. By virtue of its slotlike shape, the receiving opening has two long and two short peripheral portions in cross section. The two long peripheral portions are assigned two mutually opposite wall regions in the interior of the visor body. The wall regions are approximately parallel and delimit the receiving area arranged in the visor body.

Ribs which are oriented in the direction of insertion protrude from both wall regions into the cross section of the receiving element. To enable the object to be pushed onto the ribs, said ribs are designed to slope down toward the receiving opening.

The ribs of the opposite wall regions are arranged substantially parallel beside one another and offset with respect to one another and have, at least in the receiving area which is to the rear in the direction of insertion, a height such that they in each case protrude into the region between the ribs of the opposite wall region.

If the object is introduced into the receiving area through the receiving opening, it bears against the ribs in the region thereof which slopes down toward the receiving opening. During further insertion, the object is bent and wedged along its edge which is at the front in the direction of insertion by means of the ribs protruding one within the other from the opposite wall regions.

The function of the ribs protruding mutually one within the other can also be formed for example by corresponding surfaces, such as undulating profiles, by surface edges or else by elastic elements with corresponding contours. The functional elements described may be formed by a separate component or by one or by both half-shells of the sun visor.

An embodiment of the sun visor shows a special coating on the inner surfaces of the half-shells with which the inserted object comes into contact. This may be, for example, an applied coating material, a glued-on film or else a thin metal plate. An embodiment of the above-described foam body for elastically wedging the object may be designed for example with a film surface. The particular design of the bearing regions with materials which aid the sliding process as a result of particular smoothness, hardness or particularly low adhesion makes it possible to facilitate the introduction of the objects, particularly when they have a low bending stiffness, as in the case of pieces of paper.

In a particular embodiment of the sun visor, the slotlike receiving opening is arranged on one of the faces of the sun visor and a built-in mirror is provided in the opposite face. In this sun visor, the rear of the mirror can be used as a sliding surface. Edges, ribs and walls of the mirror housing may also serve as a bearing contour or as an introduction boundary.

Proposed embodiments are represented in the drawing figures.

### BRIEF DESCRIPTION OF THE DRAWINGS

FIG. 1 is a view of a sun visor according to the invention,

FIG. 2 shows a sectional representation of FIG. 1 through the sun visor along the plane A-A,

FIG. 3 shows a sectional representation of a sun visor with representation of a spring clip arranged in the receiving area,

FIG. 4 shows a sectional representation of a sun visor with representation of inner ribs,

FIG. 5 is a cross-sectional view of a slotlike receiving opening, viewed in the direction of the insertion movement, with interlaced ribs, and

FIG. 6 shows a section along the plane B-B shown in FIG. 5.

### DETAILED DESCRIPTION OF THE INVENTION

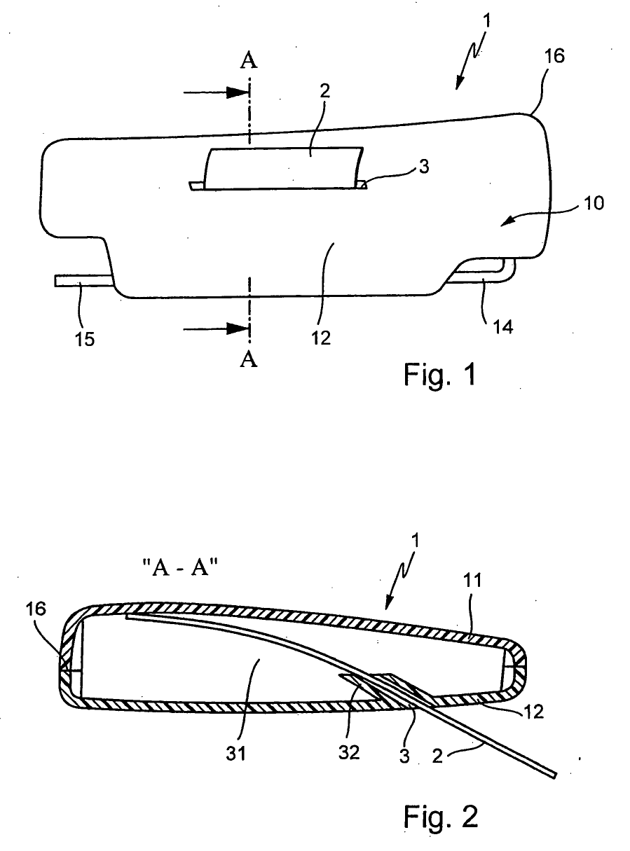

FIG. 1 shows a sun visor 1 according to the invention in a view toward that face of the sun visor which is directed toward the occupant in the inoperative position. The sun visor has a visor body 10 which is formed by two jointed half-shells, of which only the half-shell 12 can be seen in this view. A separating joint 16 between the two half-shells 11 and 12 runs along the peripheral rounded edge of the visor body 10. The sun visor 1 has still further components, such as, for example, fastening means 14 and 15 for mounting on the vehicle. A slotlike receiving opening 3, in which a flat object 2, in this case a parking ticket, is introduced and held, is formed in one face of the visor body 10. In the sun visor shown, the receiving opening 3 is formed without further components by the visor body 10 or by a half-shell 12.

FIG. 2 shows a section along plane A-A in FIG. 1. The sun visor 1 is represented with its hollow visor body 10, composed of the half-shell 11 and of a half-shell 12. The half-shells 11 and 12 form the separating joint 16 along the rounded peripheral edge of the visor body 10. An elongate elastic object 2, for example a parking ticket, is inserted through the receiving opening 3 into the receiving area 31 arranged in the cavity of the sun visor 1. The receiving opening is formed by the half-shell 12 and is provided with an inner collar 32 which skirts around the receiving opening 3. During insertion, the object 2 first of all moves at an acute angle toward the half-shell 11 situated opposite in the cavity of the visor body and comes to rest there. During further insertion, the object 2 is supported on the half-shell 11 on the one hand and in the receiving opening 3 or its collar 32 on the other hand. Thus, with its corresponding intrinsic elasticity, the object 2 is bent and becomes wedged between the bearing points.

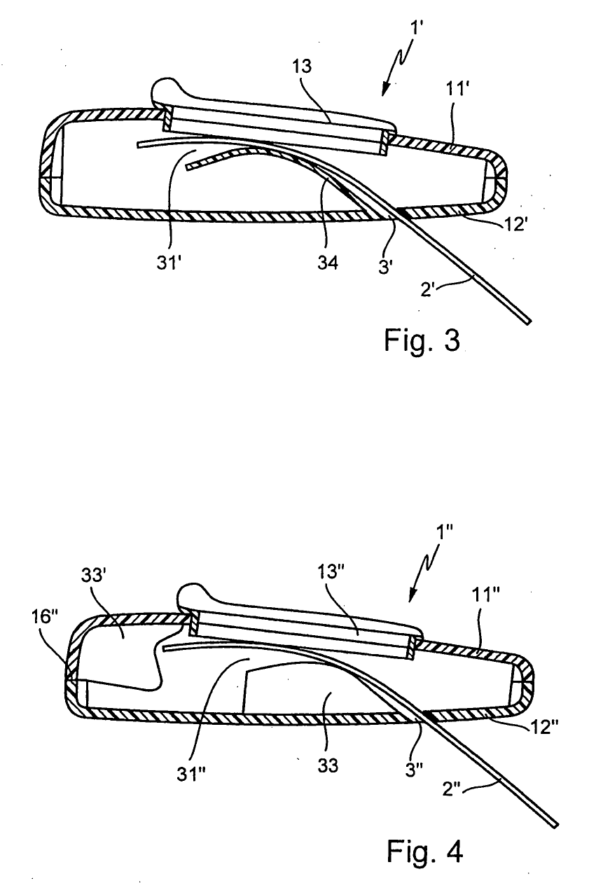

FIG. 3 shows a section through a sun visor 1′ in whose inner receiving area 31′ is arranged a spring clip 34. This spring clip 34 forms an elastic bearing point which allows relatively stiff objects to be held clamped. The elastic flexibility also provides improved retention of somewhat thicker objects, provided that the receiving opening 3′ has a correspondingly large design. An object 2′ is introduced through a receiving opening 3′ into the receiving area 31′. A mirror 13 with a lid is set in the half-shell 11′ of the sun visor 1′. The bearing and clamping point of the spring clip 34 is arranged approximately centrally between the rigid bearing points on the receiving opening 3′ and on the mirror 13. The rear of the mirror 13 has a particularly smooth and hard surface, so that the bearing object 2′ slides well during further insertion and is wedged in an improved manner.

FIG. 4 shows a sun visor 1″which has one or more ribs 33 situated one behind the other in the direction of view, the edge of the rib which protrudes into the cavity forming a guide contour for the insertion movement and a bearing point for the clamped and retained object 2″. The rib thus bounds by way of this edge a receiving area 31″ in the cavity of the sun visor 1″. Provided in the cavity are further ribs 33′ against which the object 2″, when being inserted, bears and is supported by way of its edge which is at the front in the direction of insertion. These ribs thereby bound the insertion path and thus likewise the inner receiving area 31″.

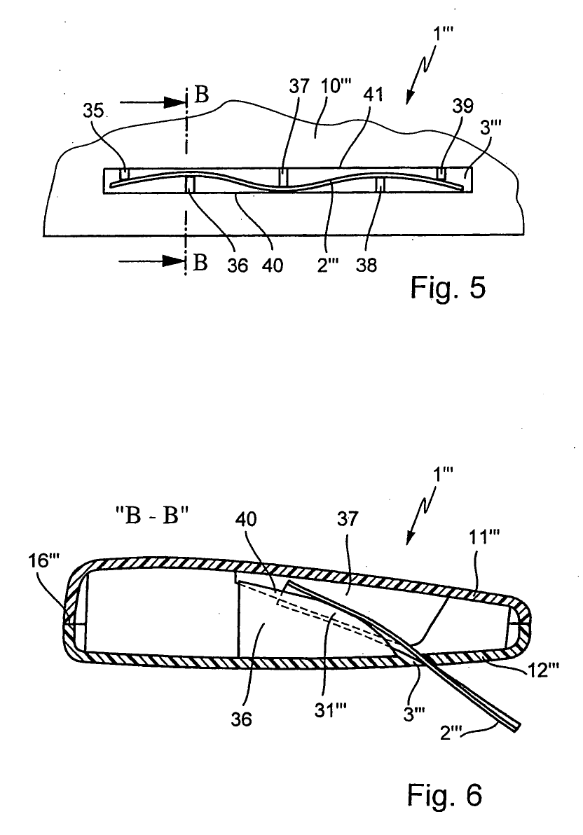

FIG. 5 shows, in a view in the direction of insertion, a region of a visor body 10′″ with a receiving opening 3′″ arranged therein. Ribs 35-39 protrude into the cross section of the receiving opening 3′″ from the wall regions of the visor cavity which are assigned to the elongate peripheral portions 40 and 41 of the receiving opening. The ribs 35-39 have, at least over part of their extent along the direction of insertion, a height such that each rib protrudes into the region between the two laterally adjacent ribs of the opposite wall region. The object 2′″ inserted between these ribs 35-39 is bent along its edge which is at the front in the direction of insertion and is clamped in this way. At the same time, the object 2′″ assumes a corrugated shape in the bent region.

FIG. 6 shows, along the plane B-B in FIG. 5, the sun visor with ribs 35-39 which protrude one within the other in a receiving area 31′″. What can be seen in this sectional view is the rib 36 which bends the object 2′″ in the direction of the opposite half-shell 11′″ and, situated behind, the rib 37 which bends the object again in the direction of the opposite half-shell 12′″. The rib 36 here is made in one part with the half-shell 12′″, and the rib 37 is made in one part with the half-shell 11. The ribs 36 and 37 have a sloping contour with respect to the receiving opening 3′″, so that the object 2′″ can be pushed through the receiving opening 3′″ onto the ribs. Continuing further in the direction of insertion, the rib 36 protrudes beyond the edge of the rib 37 into the region between the rib 37 and the immediately adjacent rib of the half-shell 11′″.

1-6. (canceled)

7. A sun visor for motor vehicles, comprising a hollow visor body and a receiving element for holding a flat object, such as a fuel card or a parking ticket, a slotlike receiving opening being formed in the visor body, through which receiving opening the object can be inserted into a receiving area which is arranged in the cavity of the visor body, wherein the sun visor has two jointed half-shells, wherein at least one of said two half-shells has the slotlike receiving opening, and wherein the object is able to be held in the interior of the sun visor by being wedged between the two half-shells.

8. The sun visor as claimed in claim 7, wherein the receiving opening is formed in the at least one of said two half-shells in the region of a separating joint with respect to the other half-shell of the sun visor.

9. The sun visor as claimed in claim 7, wherein at least one of the half-shells has ribs on its inner side which are used to guide the object received.

10. The sun visor as claimed in claim 7, wherein an elastically flexible bearing region is formed in the receiving area.

11. The sun visor as claimed in claim 7, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.

12. The sun visor as claimed in claim 7, wherein, on its inner side, one of the half-shells has coatings or inlays over bearing regions for the object.

13. The sun visor as claimed in claim 8, wherein at least one of the half-shells has ribs on its inner side which are used to guide the object received.

14. The sun visor as claimed in claim 8, wherein an elastically flexible bearing region is formed in the receiving area.

15. The sun visor as claimed in claim 9, wherein an elastically flexible bearing region is formed in the receiving area.

16. The sun visor as claimed in claim 8, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.

17. The sun visor as claimed in claim 9, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.

18. The sun visor as claimed in claim 10, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.

19. The sun visor as claimed in claim 8, wherein, on its inner side, one of the half-shells has coatings or inlays over bearing regions for the object.

20. The sun visor as claimed in claim 9, wherein, on its inner side, one of the half-shells has coatings or inlays over bearing regions for the object.

21. The sun visor as claimed in claim 10, wherein, on its inner side, one of the half-shells has coatings or inlays over bearing regions for the object.

22. The sun visor as claimed in claim 11, wherein, on its inner side, one of the half-shells has coatings or inlays over bearing regions for the object.

23. The sun visor as claimed in claim 13, wherein an elastically flexible bearing region is formed in the receiving area.

24. The sun visor as claimed in claim 13, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.

25. The sun visor as claimed in claim 14, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.

26. The sun visor as claimed in claim 15, wherein the object is bent along its edge which is at the front in the direction of insertion and is clamped in this way, and wherein, for this purpose, ribs, which are oriented along the direction of insertion, protrude from two opposite walls of the receiving area, mutually forming a covering.
